(19) United States
(12) Patent Application Publication
(10) Pub. No.: US 2006/0292539 A1
(43) Pub. Date: Dec. 28, 2006

(54) Adaptively user-centric authentication/security

(76) Inventors: Edward K.Y. Jung, Bellevue, WA (US); Robert W. Lord, Seattle, WA (US); Royce A. Levien, Lexington, MA (US); Mark A. Malamud, Seattle, WA (US); John D. Rinaldo JR., Bellevue, WA (US)

Correspondence Address: ANDERSON & JANSSON, L.L.P., 9501 N. CAPITAL OF TX HWY. #202, AUSTIN, TX, 78759, US

(21) Appl. No.: 11/169,174

(22) Filed: Jun. 28, 2005

(51) Int. Cl. G09B 3/00; G09B 7/00

(52) U.S. Cl. 434/322

(57) ABSTRACT

A system and method for use with a voice-capable system, includes but is not limited to posing at least one question for which at least one associated-correct answer is known; receiving one or more answers to the at least one question for which the at least one associated-correct answer is known; posing at least one question for which at least one associated-correct answer is unknown; receiving one or more answers to the at least one question for which the at least one associated-correct answer is unknown; and storing at least one of the one or more answers to the at least one question for which the at least one associated-correct answer is unknown.

### TECHNICAL FIELD

The present application relates generally to security systems.

### SUMMARY

In one aspect, a method for use with a voice-capable system includes posing at least one question for which at least one associated-correct answer is known; receiving one or more answers to the at least one question for which the at least one associated-correct answer is unknown; posing at least one question for which at least one associated-correct answer is unknown; receiving one or more answers to the at least one question for which the at least one associated-correct answer is unknown; and storing at least one of the one or more answers to the at least one question for which the at least one associated-correct answer is unknown. In addition to the foregoing, other method aspects are described in the claims, drawings, and text forming a part of the present application.

In another aspect, a computer program product can include a signal bearing medium bearing one or more instructions including, but not limited to one or more instructions for posing at least one question for which at least one associated-correct answer is known; one or more instructions for receiving one or more answers to the at least one question for which the at least one associated-correct answer is known; one or more instructions for posing at least one question for which at least one associated-correct answer is unknown; one or more instructions for receiving one or more answers to the at least one question for which the at least one associated-correct answer is unknown; and one or more instructions for storing at least one of the one or more answers to the at least one question for which the at least one associated-correct answer is unknown. In addition to the foregoing, other computer program product aspects are described in the claims, drawings, and text forming a part of the present application.

In one or more various aspects, related systems include but are not limited to circuitry and/or programming for effecting the herein-referenced method aspects; the circuitry and/or programming can be virtually any combination of hardware, software, and/or firmware configured to effect the herein-referenced method aspects depending upon the design choices of the system designer. In addition to the foregoing, other system aspects are described in the claims, drawings, and text forming a part of the present application.

In one aspect, a communication device includes but is not limited to a processor, an audio input and/or output circuitry coupled to the processor, a memory coupled to the processor, and a security module coupled to the processor, the security module configured to determine whether the processor should implement a secure protocol, the secure protocol configured to implement an automated system with one or more questions related to security/authentication and/or fact gathering, the security module configured to include a question and/or answer module configured to pose at least one question for which at least one associated-correct answer is known, receive one or more answers to the at least one question for which the at least one associated-correct answer is known, pose at least one question for which the at least one associated-correct answer is unknown, receive one or more answers to the at least one question for which the at least one associated-correct answer is unknown, and store the one or more answers to the at least one question for which the at least one associated-correct answer is unknown In addition to the foregoing, other communication device aspects are described in the claims, drawings, and text forming a part of the present application.

In addition to the foregoing, various other method, system, and/or computer program product aspects are set forth and described in the text (e.g., claims and/or detailed description) and/or drawings of the present application.

The foregoing is a summary and thus contains, by necessity, simplifications, generalizations and omissions of detail; consequently, those skilled in the art will appreciate that the summary is illustrative only and is NOT intended to be in any way limiting. Other aspects, features, and advantages of the devices and/or processes and/or other subject described herein will become apparent in the text set forth herein.

### BRIEF DESCRIPTION OF THE DRAWINGS

A better understanding of the subject matter of the application can be obtained when the following detailed description of the disclosed embodiments is considered in conjunction with the following drawings, in which:

FIG. 1 is a block diagram of an exemplary computer architecture that supports the claimed subject matter of the present application;

FIG. 2 is a block diagram of a network environment that supports the claimed subject matter of the present application;

FIG. 3 is a block diagram of a communication device appropriate for embodiments of the subject matter of the present application; and

FIGS. 4A, 4B and 4C illustrate a flow diagram of a method in accordance with an embodiment of the subject matter of the present application.

### DETAILED DESCRIPTION OF THE DRAWINGS

In the description that follows, the subject matter of the application will be described with reference to acts and symbolic representations of operations that are performed by one or more computers, unless indicated otherwise. As such, it will be understood that such acts and operations, which are at times referred to as being computer-executed, include the manipulation by the processing unit of the computer of electrical signals representing data in a structured form. This manipulation transforms the data or maintains it at locations in the memory system of the computer which reconfigures or otherwise alters the operation of the computer in a manner well understood by those skilled in the art. The data structures where data is maintained are physical locations of the memory that have particular properties defined by the format of the data. However, although the subject matter of the application is being described in the foregoing context, it is not meant to be limiting as those of skill in the art will appreciate that some of the acts and operations described hereinafter can also be implemented in hardware, software, and/or firmware and/or some combination thereof.

According to William Crossman, Founder/Director of CompSpeak 2050 Institute for the Study of Talking Computers and Oral Cultures, VIVOs, (e.g., voice-in/voice-out computers that may operate using visual displays) may make written language obsolete. VIVOs potentially can perform the functions of written language without requiring people to learn to read and write and, therefore, enable illiterate people, using VIVOs, to access the stored information.

Opening the doors for potentially billions of people to electronically-stored data presents a host of issues related to security and/or authentication. More particularly, according to Crossman, billions of illiterate people will be able to access data previously available only to the computer literate. The increase in the number of people with access to the Internet will increase the need for security systems that address the enhanced security risk. Moreover, VIVO technology will increase the number of security systems reliant on voice commands and subject users to security risks present with voice related systems.

To combat the security risk inherent in a VIVO system, embodiments herein present authentication and/or security solutions practical for voice related security.

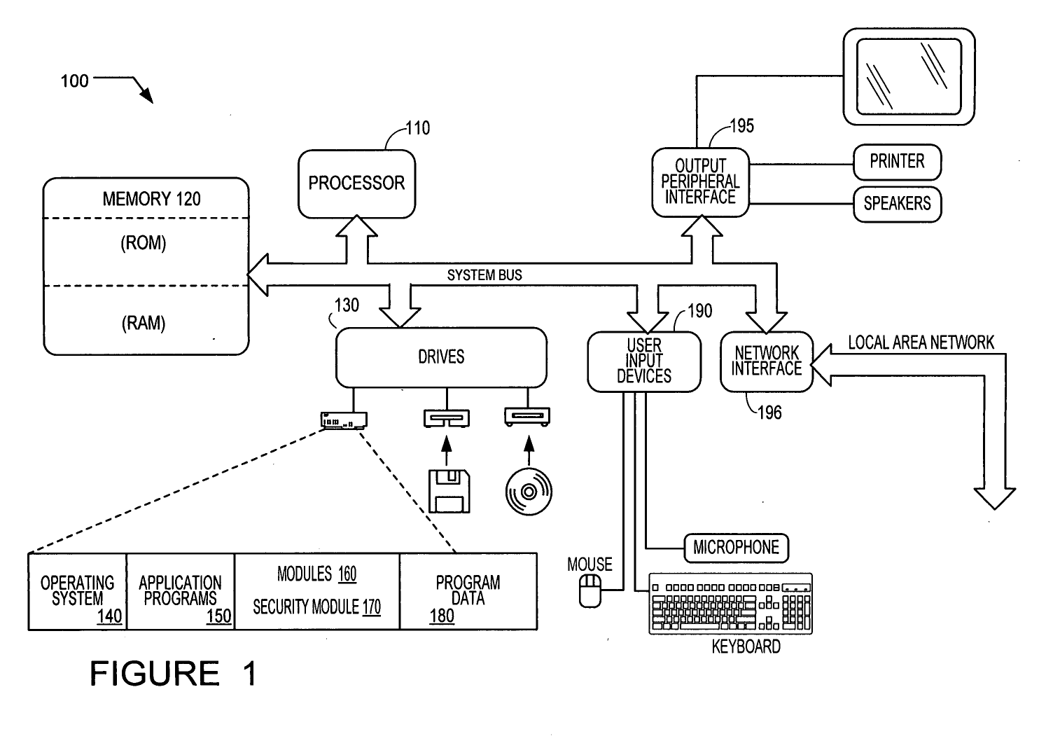

With reference to FIG. 1, depicted is an exemplary computing system for implementing embodiments. FIG. 1 includes a computer 100, which could be a VIVO-capable computer, including a processor 110, memory 120 and one or more drives 130. The drives 130 and their associated computer storage media, provide storage of computer readable instructions, data structures, program modules and other data for the computer 100. Drives 130 can include an operating system 140, application programs 150, program modules 160, such as security module 170 and program data 180. Computer 100 further includes user input devices 190 through which a user may enter commands and data. Input devices can include an electronic digitizer, a microphone, a keyboard and pointing device, commonly referred to as a mouse, trackball or touch pad. Other input devices may include a joystick, game pad, satellite dish, scanner, or the like. In one or more embodiments, user input devices 190 are VIVO enabling devices, enabling a user to provide voice activated responses and/or questions.

These and other input devices can be connected to processor 110 through a user input interface that is coupled to a system bus, but may be connected by other interface and bus structures, such as a parallel port, game port or a universal serial bus (USB). Computers such as computer 100 may also include other peripheral output devices such as speakers, which may be connected through an output peripheral interface 195 or the like. More particularly, output devices can include VIVO enabling devices capable of providing voice output in response to voice input.

Computer 100 may operate in a networked environment using logical connections to one or more remote computers, such as a remote computer. The remote computer may be a personal computer, a server, a router, a network PC, a peer device or other common network node, and can include many or all of the elements described above relative to computer 100. Networking environments are commonplace in offices, enterprise-wide computer networks, intranets and the Internet. For example, in the subject matter of the present application, computer 100 may comprise the source machine from which data is being migrated, and the remote computer may comprise the destination machine. Note however that source and destination machines need not be connected by a network or any other means, but instead, data may be migrated via any media capable of being written by the source platform and read by the destination platform or platforms. When used in a LAN or WLAN networking environment, computer 100 is connected to the LAN through a network interface 196 or adapter. When used in a WAN networking environment, computer 100 typically includes a modem or other means for establishing communications over the WAN, such as the Internet. It will be appreciated that other means of establishing a communications link between the computers may be used.

According to one embodiment, computer 100 is connected in a networking environment such that the processor 110 and/or security module 170 determine whether incoming data follows a secure protocol. The incoming data can be from a VIVO communication device or from another data source. The secure protocol can be code stored in memory 120. For example, processor 110 can determine whether an incoming call is from a VIVO, determine that a secure protocol is necessary and apply an appropriate authentication.

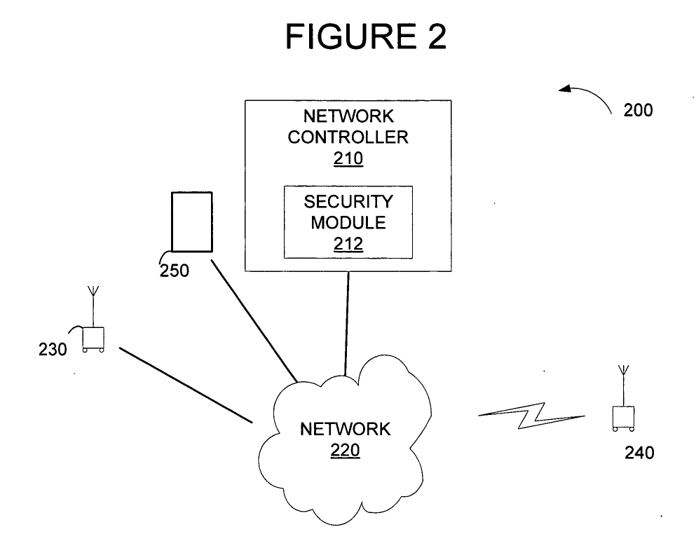

Referring now to FIG. 2, illustrated is an exemplary block diagram of a system 200 capable of being operable with VIVO computer systems and interacting with a VIVO-type computer system. System 200 is shown including network controller 210, a network 220, and one or more communication devices 230, 240, and 250. Communication devices 230, 240, and 250 may include telephones, wireless telephones, cellular telephones, personal digital assistants, computer terminals or any other devices that are capable of sending and receiving data.

Network controller 210 is connected to network 220. Network controller 210 may be located at a base station, a service center, or any other location on network 220. Network 220 may include any type of network that is capable of sending and receiving communication signals, including VIVO-type signals. For example, network 220 may include a data network, such as the Internet, an intranet, a local area network (LAN), a wide-area network (WAN), a cable network, and other like communication systems. Network 220 may also include a telecommunications network, such as a local telephone network, long distance telephone network, cellular telephone network, satellite communications network, cable television network and other like communications systems that interact with computer systems. Network 220 may include more than one network and may include a plurality of different types of networks. Thus, network 220 may include a plurality of data networks, a plurality of telecommunications networks, and a combination of data and telecommunications networks and other like communication systems.

In operation, one of the communication devices 230, 240, or 250, may attempt a communication with a receiving communication device. The communication can be routed through network 220 and network controller 210 to the receiving communication device. For example, a call originator communication device 230 may attempt a call to a call recipient communication device 240. In an embodiment, controller 210 is a VIVO-enabled controller such that an audible format may be a speech format. According to an embodiment, controller 210 can include a security module 212 that can poll the caller and a call recipient 240 during call setup to pose authentication questions to secure a connection. For example, a call could be to a bank or other recipient with sensitive data requiring security.

Controller 210 can alter the format of the call by performing speech-to-text conversion on the call when controller 210 determines the format of the call requires a format change. Controller 210 can additionally alter the format of the call by performing text-to-speech conversion on the call when controller 210 determines the format of the call requires a format change. Controller 210 can then send the call in an appropriate format to the call recipient 240. In one embodiment, controller 210 is a VIVO-enabled controller that alters speech to text or speech to computer code in accordance with the requirements of a VIVO.

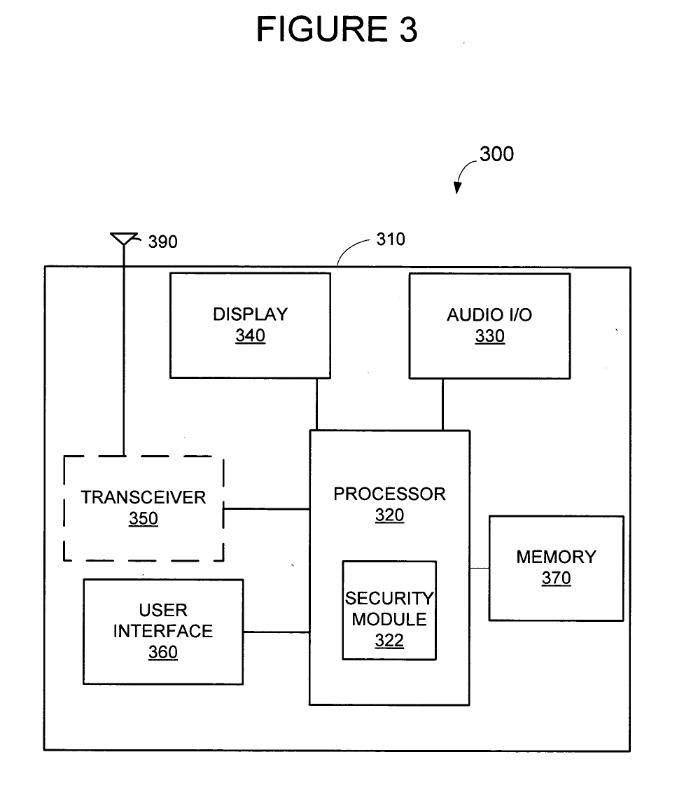

FIG. 3 is an exemplary block diagram of a communication device 300, such as communication device 230 or 240 according to an embodiment. Communication device 300 can include a housing 310, a processor 320, audio input and output circuitry 330 coupled to processor 320, a display 340 coupled to processor 320, a user interface 360 coupled to processor 320 and a memory 370 coupled to processor 320. According to an embodiment, processor 320 includes security module 322. Security module 322 may be hardware coupled to the processor 320. Alternatively, security module 322 could be located within processor 320, or located in software located in memory 370 and executed by processor 320, or any other type of module. Memory 370 can include a random access memory, a read only memory, an optical memory, a subscriber identity module memory, or any other memory that can be coupled to a communication device. Display 340 can be a liquid crystal display (LCD), a light emitting diode (LED) display, a plasma display, or any other means for displaying information. Audio input and output circuitry 330 can include a microphone, a speaker, a transducer, or any other audio input and output circuitry. User interface 360 can include a keypad, buttons, a touch pad, a joystick, an additional display, or any other device useful for providing an interface between a user and an electronic device.

Processor 320 can be configured to control the functions of communication device 300. Communication device 300 can send and receive signals across network 220 using a transceiver 350 coupled to antenna 390. Alternatively, communication device 300 can be a device relying on twisted pair technology and not utilize transceiver 350.

According to an embodiment, a user can use either the user interface 360 for input and output of information to and from communication device 300 or use input and output using the audio input and output circuitry 330. Data received by communication device 300 can be displayed on display 340 and/or provided audibly through audio input and output circuitry 330. Communication device 300 can operate as a VIVO when operated in a fully audible format. For example, VIVO applications can be stored on memory 370 and processed by processor 320.

According to one embodiment, the processor 320 and/or security module 322 can determine whether an incoming call follows a secure protocol. The secure protocol can be code stored in memory 370. For example, processor 320 can determine an incoming call is from a VIVO, determine that a secure protocol is necessary and apply an appropriate authentication. Conversely, processor 320 and/or security module 322 can determine that an outgoing call should follow a secure protocol and implement the secure protocol.

In one embodiment, either or both computer 100 and communication device 300 operate as VIVOs that are capable of implementing a secure protocol for incoming and/or outgoing audible data and/or speech. The secure protocol, in one embodiment, implements a user-centric question and answer to authenticate one or both of incoming and outgoing data when an auditory format is detected. For example, if computer 100 or communication device 300 is used to communicate with a bank, the bank could implement a secure protocol by operating a computer 100 with a security module or a communication device 300 with a security module. Likewise, the bank could operate via a secure network such as a network described in FIG. 2, and implement a secure protocol via network controller 210 implementing a security protocol via a security module.

In one embodiment, the security module is configured to determine whether a processor (e.g., in either computer 100, communication device 300, or in a network controller) should implement a secure protocol, the secure protocol configured to implement a user-centric authentication. More particularly, the security module could include a question module configured to pose questions in response to an authentication request. In an embodiment, the secure protocol could implement an automated system that presents the questions. In one embodiment, the questions relate to security and/or authentication and other questions include questions that do not have answers known by the system but instead are to be utilized as fact gathering questions. The questions that do not relate to a current security and/or authentication can be utilized in future security/authentication question and answer sessions. For example, the system could be configured to “learn” in response to the answers received. Once a system “learns” in response to answers provided by a user, the system can store the answers for use in future authentication/security interactions.

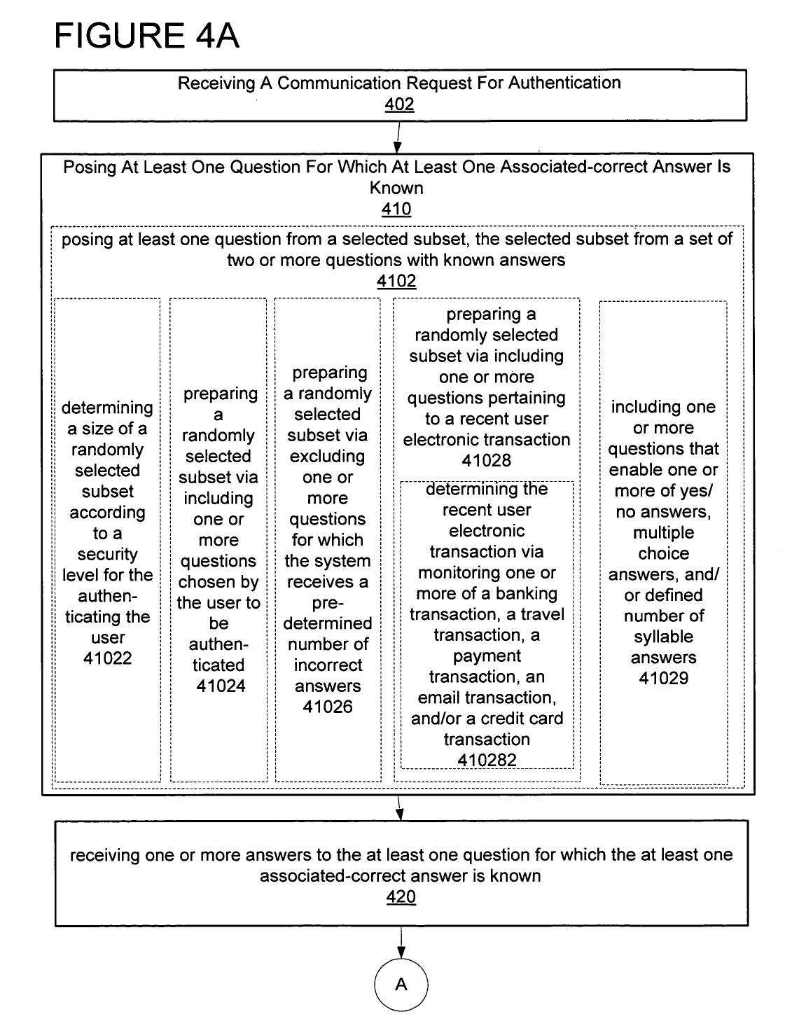

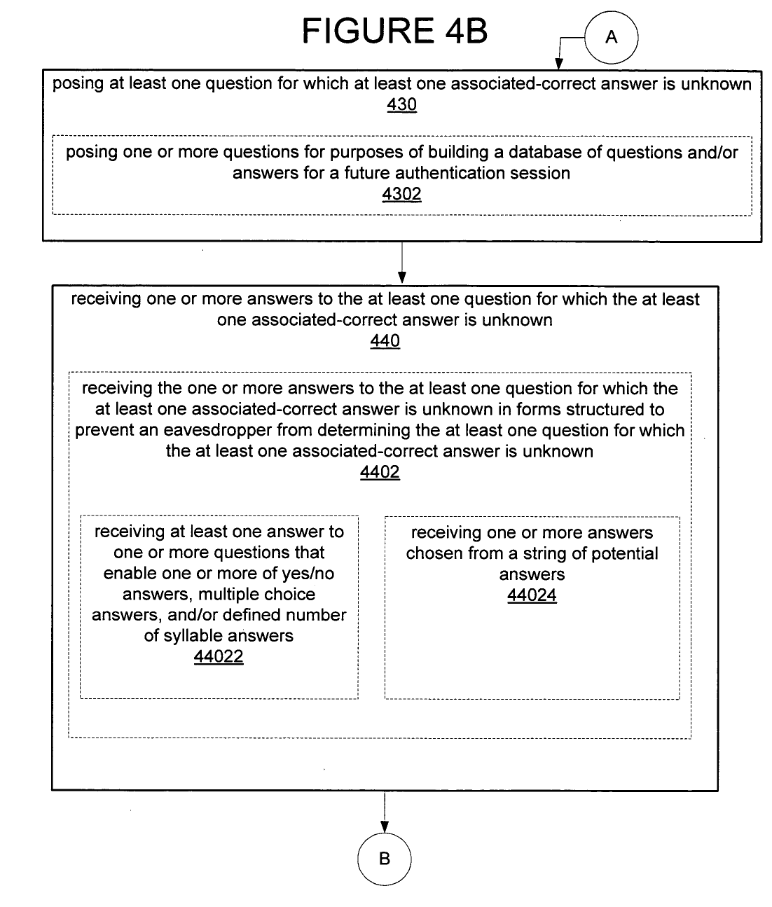

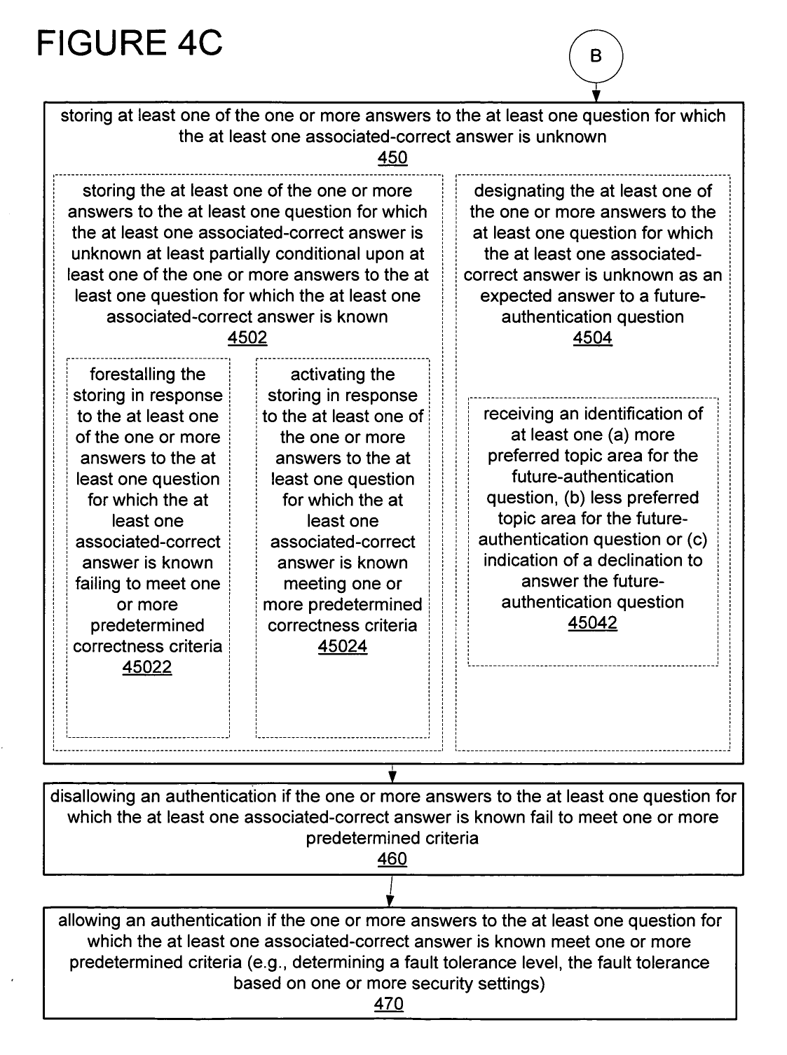

Referring now to FIGS. 4A, 4B and 4C, an exemplary flow diagram illustrates the operation of the processor 320 and/or security module 322 and/or network controller 210 according to an embodiment. One of skill in the art with the benefit of the present disclosure will appreciate that act(s) can be taken by security module 322, network controller 210, processor 110, and/or security module 170. The acts are generally referred to as being taken by a security processor.

FIGS. 4A, 4B and 4C provide methods for use with a voice-capable system, such as a system capable of receiving a communication request for authentication, as shown in block 402. The request could be an oral request over a telephone to a security processor from a VIVO or the like. For example, a bank can receive a request to authenticate a customer, or the like. A security processor can determine that an authentication session is required. For example, the determination can be a determination by a bank that a user wishes to log into the bank. The determination can include a determination that a user is using a telephone to log into the bank via audible-only methods of communication. For example, a bank can operate via a network capable of accepting auditory communications from a user and have a computer, such as computer 100, or network controller 210, respond with auditory communications back to the user.

Block 410 provides for posing at least one question for which at least one associated-correct answer is known. More particularly, a security module can be configured to pose at least one question to a user requesting authentication, and at least one associated-correct answer to the question is known to a system including the security module. The associated-correct answer can be known via being located within the system or being accessible to the system.

Depicted within block 410 is optional block 4102, which provides for posing at least one question from a selected subset, the selected subset from a set of two or more questions with known answers. In one embodiment, the system including the security module determines a selected subset of known questions from a set of two or more questions with known answers. The selected subset can be selected via a random process, pseudo-random process or the like. The number of random selections could be based on a security level.

Block 4102 includes optional blocks 41022, 41024, 41026, 41028 and 41029. Block 41022 provides for determining a size of a randomly selected subset according to a security level for the authenticating the user. In an embodiment, the size can be a function of the security level such that a more secure authentication requires a larger subset.

Optional block 41024 provides for preparing a randomly selected subset via including one or more questions chosen by the user to be authenticated. In an embodiment, the questions chosen by a user, for example, can be those from a prior authentication or questions chosen by the security module.

Block 41026 provides for preparing a randomly selected subset via excluding one or more questions for which the system receives a predetermined number of incorrect answers. For example, a security module could be configured to determine that a user frequently answers a question incorrectly and determine that the question is invalid if the user is nonetheless authenticated.

Block 41028 provides for preparing a randomly selected subset via including one or more questions pertaining to a recent user electronic transaction. For example, a user that has been on vacation could be queried regarding transactions from the vacation or other electronic transactions recently performed by the user. Depicted within block 41028 is optional block 410282, which provides for determining the recent user electronic transaction via monitoring one or more of a banking transaction, a travel transaction, a payment transaction, an email transaction, and/or a credit card transaction.

Block 41029 provides for including one or more questions that enable one or more of yes/no answers, multiple choice answers, and/or defined number of syllable answers. The defined number of syllable answers can be determined via a random or pseudo-random process, and could be a function of whether the answers are limited to yes and no type questions and the like.

Block 420 provides for receiving one or more answers to the at least one question for which the at least one associated-correct answer is known. For example, a security module could receive answers that match an answer in a database.

Block 430 provides for posing at least one question for which at least one associated-correct answer is unknown. In an embodiment, an associated-correct answer could be collected to be used in future authentication sessions with the user to provide an additional layer of security.

Depicted within block 430 is block 4302, which provides for posing one or more questions for purposes of building a database of questions and/or answers for a future authentication session. For example, the database could be accessible to a security module to enable authentication that is user-centric, user-friendly, and yet secure.

Block 440 provides for receiving one or more answers to the at least one question for which the at least one associated-correct answer is unknown. For example, a secure module could receive an answer to a question for which an associated-correct answer is unknown and store the answer in a database for future use. Depicted within block 440 is block 4402, which provides for receiving the one or more answers to the at least one question for which the at least one associated-correct answer is unknown in forms structured to prevent an eavesdropper from determining the at least one question for which the at least one associated-correct answer is unknown in forms structured to prevent an eavesdropper from determining an associated question. For example, if an eavesdropper can listen to only the answers, the questions could be either “yes” or “no”, could be “a”, “b”, “c”, “d” or the like. Additionally, the answer could be “stop” in response to a list presented to a user, for which the user is asked to respond “stop” upon hearing a correct answer. Thus, if an eavesdropper can only hear the user responses, the responses would not provide information as to the type of question or content of a question posed to the user.

Also depicted within block 4402 is block 44022, which provides for receiving at least one answer to one or more questions that enable one or more of yes/no answers, multiple choice answers, and/or defined number of syllable answers.

Also depicted within block 4402 is block 44024, which provides for receiving one or more answers chosen from a string of potential answers. For example, a response received could include “stop” by a user during a recitation of the string of optional answers. The optional answers could be multiple choice answers, or another type of string of optional answers.

Block 450 provides for storing at least one of the one or more answers to the at least one question for which the at least one associated-correct answer is unknown.

Depicted within block 450 is optional block 4502, which provides for storing the at least one of the one or more answers to the at least one question for which the at least one associated-correct answer is unknown at least partially conditional upon at least one of the one or more answers to the at least one question for which the at least one associated-correct answer is known. For example, if a question is asked for which an answer is unknown is posed; a security module could be configured to store the question only after a determination that the user can be properly authenticated. Thus, an eavesdropper can be prevented from creating questions to be posed to the eavesdropper an enable an authentication.

Depicted within block 4502 is optional block 45022, which provides for forestalling the storing in response to the at least one of the one or more answers to the at least one question for which the at least one associated-correct answer is known failing to meet one or more predetermined correctness criteria. For example, storing the response could be prevented if a user answering a predetermined number of questions incorrectly.

Also depicted within block 4502 is optional block 45024, which provides that the storing the at least one of the one or more answers to the at least one question for which the at least one associated-correct answer is unknown at least partially conditional upon at least one of the one or more answers to the at least one question for which the at least one associated-correct answer is known can include activating the storing in response to the at least one of the one or more answers to the at least one question for which the at least one associated-correct answer is known meeting one or more predetermined correctness criteria. For example, a user that answers a predetermined number of questions correctly, could activate the storing. The predetermined correctness criteria could include a number of criteria aside from a number of questions answered correctly. For example, other criteria not related to content could be considered. A voice-print matching, a pitch of voice, and the like could be recorded and compared to a stored voice-print and pitch for the user.

Block 450 further includes optional block 4504, which provides for designating the at least one of the one or more answers to the at least one question for which the at least one associated-correct answer is unknown as an expected answer to a future-authentication question.

Block 4504 includes optional block 45042, which provides that the designating the at least one of the one or more answers to the at least one question for which the at least one associated-correct answer is unknown as an expected answer to a future-authentication question includes receiving an identification of at least one (a) more preferred topic area for the future-authentication question, (b) less preferred topic area for the future-authentication question, or (c) indication of a declination to answer the future-authentication question. For example, in an embodiment, a security module could be configured to enable a user-centric authorization that allows a user to determine a topic area for a future authentication.

Block 460 provides for disallowing an authentication if the one or more answers to the at least one question for which the at least one associated-correct answer is known fail to meet one or more predetermined criteria. For example, if a certain number of answers are incorrectly answered, or if a certain number of answers are provided that are determined to be machine generated, an authentication would be disallowed.

Block 470 provides for allowing an authentication if the one or more answers to the at least one question for which the at least one associated-correct answer is known meet one or more predetermined criteria. Converse to the authentication, the predetermined criteria could include criteria that determine whether a user is a human or machine, whether an appropriate number of correct answers were received and the like.

Depicted within block 470 is an example which provides that the allowing an authentication if the one or more answers to the at least one question for which the at least one associated-correct answer is known meet one or more predetermined criteria includes determining a fault tolerance level, the fault tolerance based on one or more security settings. For example, a fault tolerance level could include determining an authentication based on the type of transaction a user wishes to make.

Those with skill in the computing arts will recognize that the disclosed embodiments have relevance to a wide variety of applications and architectures in addition to those described above. In addition, the functionality of the subject matter of the present application can be implemented in software, hardware, or a combination of software and hardware. The hardware portion can be implemented using specialized logic; the software portion can be stored in a memory or recording medium and executed by a suitable instruction execution system such as a microprocessor.

While the subject matter of the application has been shown and described with reference to particular embodiments thereof, it will be understood by those skilled in the art that the foregoing and other changes in form and detail may be made therein without departing from the spirit and scope of the subject matter of the application, including but not limited to additional, less or modified elements and/or additional, less or modified blocks performed in the same or a different order.

Those having skill in the art will recognize that the state of the art has progressed to the point where there is little distinction left between hardware and software implementations of aspects of systems; the use of hardware or software is generally (but not always, in that in certain contexts the choice between hardware and software can become significant) a design choice representing cost vs. efficiency tradeoffs. Those having skill in the art will appreciate that there are various vehicles by which processes and/or systems and/or other technologies described herein can be effected (e.g., hardware, software, and/or firmware), and that the preferred vehicle will vary with the context in which the processes and/or systems and/or other technologies are deployed. For example, if an implementer determines that speed and accuracy are paramount, the implementer may opt for a mainly hardware and/or firmware vehicle; alternatively, if flexibility is paramount, the implementer may opt for a mainly software implementation; or, yet again alternatively, the implementer may opt for some combination of hardware, software, and/or firmware. Hence, there are several possible vehicles by which the processes and/or devices and/or other technologies described herein may be effected, none of which is inherently superior to the other in that any vehicle to be utilized is a choice dependent upon the context in which the vehicle will be deployed and the specific concerns (e.g., speed, flexibility, or predictability) of the implementer, any of which may vary. Those skilled in the art will recognize that optical aspects of implementations will typically employ optically-oriented hardware, software, and or firmware.

The foregoing detailed description has set forth various embodiments of the devices and/or processes via the use of block diagrams, flowcharts, and/or examples. Insofar as such block diagrams, flowcharts, and/or examples contain one or more functions and/or operations, it will be understood by those within the art that each function and/or operation within such block diagrams, flowcharts, or examples can be implemented, individually and/or collectively, by a wide range of hardware, software, firmware, or virtually any combination thereof. In one embodiment, several portions of the subject matter described herein may be implemented via Application Specific Integrated Circuits (ASICs), Field Programmable Gate Arrays (FPGAs), digital signal processors (DSPs), or other integrated formats. However, those skilled in the art will recognize that some aspects of the embodiments disclosed herein, in whole or in part, can be equivalently implemented in standard integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and or firmware would be well within the skill of one of skill in the art in light of this disclosure. In addition, those skilled in the art will appreciate that the mechanisms of the subject matter described herein are capable of being distributed as a program product in a variety of forms, and that an illustrative embodiment of the subject matter described herein applies equally regardless of the particular type of signal bearing media used to actually carry out the distribution. Examples of a signal bearing media include, but are not limited to, the following: recordable type media such as floppy disks, hard disk drives, CD ROMs, digital tape, and computer memory; and transmission type media such as digital and analog communication links using TDM or IP based communication links (e.g., packet links).

The herein described aspects depict different components contained within, or connected with, different other components. It is to be understood that such depicted architectures are merely exemplary, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled”, to each other to achieve the desired functionality, and any two components capable of being so associated can also be viewed as being “operably couplable”, to each other to achieve the desired functionality. Specific examples of operably couplable include but are not limited to physically mateable and/or physically interacting components and/or wirelessly interactable and/or wirelessly interacting components and/or logically interacting and/or logically interactable components.

Those skilled in the art will recognize that it is common within the art to implement devices and/or processes and/or systems in the fashion(s) set forth herein, and thereafter use engineering and/or business practices to integrate such implemented devices and/or processes and/or systems into more comprehensive devices and/or processes and/or systems. That is, at least a portion of the devices and/or processes and/or systems described herein can be integrated into comprehensive devices and/or processes and/or systems via a reasonable amount of experimentation. Those having skill in the art will recognize that examples of such comprehensive devices and/or processes and/or systems might include—as appropriate to context and application—all or part of devices and/or processes and/or systems of (a) an air conveyance (e.g., an airplane, rocket, hovercraft, helicopter, etc.), (b) a ground conveyance (e.g., a car, truck, locomotive, tank, armored personnel carrier, etc.), (c) a building (e.g., a home, warehouse, office, etc.), (d) an appliance (e.g., a refrigerator, a washing machine, a dryer, etc.), (e) a communications system (e.g., a networked system, a telephone system, a Voice over IP system, etc.), (f) a business entity (e.g., an Internet Service Provider (ISP) entity such as Comcast Cable, Quest, Southwestern Bell, etc.); or (g) a wired/wireless services entity such as Sprint, Cingular, Nextel, etc.), etc.

While particular aspects of the present subject matter described herein have been shown and described, it will be apparent to those skilled in the art that, based upon the teachings herein, changes and modifications may be made without departing from the subject matter described herein and its broader aspects and, therefore, the appended claims are to encompass within their scope all such changes and modifications as are within the true spirit and scope of this subject matter described herein. Furthermore, it is to be understood that the invention is defined by the appended claims. It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to inventions containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.).

We claim:

1. A method for use with a voice-capable system, the method comprising:
posing at least one question for which at least one associated-correct answer is known;
receiving one or more answers to the at least one question for which the at least one associated-correct answer is known;
posing at least one question for which at least one associated-correct answer is unknown;
receiving one or more answers to the at least one question for which the at least one associated-correct answer is unknown; and
storing at least one of the one or more answers to the at least one question for which the at least one associated-correct answer is unknown.

2. The method of claim 1 wherein the posing at least one question for which at least one associated-correct answer is known includes:
posing at least one question from a selected subset, the selected subset from a set of two or more questions with known answers.

3. The method of claim 2 wherein the posing at least one question from a selected subset, the selected subset from a set of two or more questions with known answers includes:
determining a size of a randomly selected subset according to a security level for the authenticating the user.

4. The method of claim 2 wherein the posing at least one question from a selected subset, the selected subset from a set of two or more questions with known answers includes:
preparing a randomly selected subset via including one or more questions chosen by the user to be authenticated.

5. The method of claim 2 wherein the posing at least one question from a selected subset, the selected subset from a set of two or more questions with known answers includes:
preparing a randomly selected subset via excluding one or more questions for which the system receives a predetermined number of incorrect answers.

6. The method of claim 2 wherein the posing at least one question from a selected subset, the selected subset from a set of two or more questions with known answers includes:
preparing a randomly selected subset via including one or more questions pertaining to a recent user electronic transaction.

7. The method of claim 6 wherein the preparing a randomly selected subset via including one or more questions pertaining to a recent user electronic transaction includes:
determining the recent user electronic transaction via monitoring one or more of a banking transaction, a travel transaction, a payment transaction, an email transaction, and/or a credit card transaction.

8. The method of claim 2 wherein the posing at least one question from a selected subset, the selected subset from a set of two or more questions with known answers includes:
including one or more questions that enable one or more of yes/no answers, multiple choice answers, and/or defined number of syllable answers.

9. The method of claim 1 wherein posing at least one question for which at least one associated-correct answer is unknown includes:
posing one or more questions for purposes of building a database of questions and/or answers for a future authentication session.

10. The method of claim 1 wherein the receiving one or more answers to the at least one question for which the at least one associated-correct answer is unknown includes:
receiving the one or more answers to the at least one question for which the at least one associated-correct answer is unknown in forms structured to prevent an eavesdropper from determining the at least one question for which the at least one associated-correct answer is unknown.

11. The method of claim 10 wherein the receiving the one or more answers to the at least one question for which the at least one associated-correct answer is unknown in forms structured to prevent an eavesdropper from determining the at least one question for which the at least one associated-correct answer is unknown includes:
receiving at least one answer to one or more questions that enable one or more of yes/no answers, multiple choice answers, and/or defined number of syllable answers.

12. The method of claim 10 wherein the receiving the one or more answers to the at least one question for which the at least one associated-correct answer is unknown in forms structured to prevent an eavesdropper from determining the at least one question for which the at least one associated-correct answer is unknown includes:
receiving one or more answers chosen from a string of potential answers.

13. The method of claim 1 wherein said storing at least one of the one or more answers to the at least one question for which the at least one associated-correct answer is unknown further comprises:
storing the at least one of the one or more answers to the at least one question for which the at least one associated-correct answer is unknown at least partially conditional upon at least one of the one or more answers to the at least one question for which the at least one associated-correct answer is known.

14. The method of claim 13 wherein said storing the at least one of the one or more answers to the at least one question for which the at least one associated-correct answer is unknown at least partially conditional upon at least one of the one or more answers to the at least one question for which the at least one associated-correct answer is known further comprises:
forestalling the storing in response to the at least one of the one or more answers to the at least one question for which the at least one associated-correct answer is known failing to meet one or more predetermined correctness criteria.

15. The method of claim 13 wherein said storing the at least one of the one or more answers to the at least one question for which the at least one associated-correct answer is unknown at least partially conditional upon at least one of the one or more answers to the at least one question for which the at least one associated-correct answer is known further comprises:
activating the storing in response to the at least one of the one or more answers to the at least one question for which the at least one associated-correct answer is known meeting one or more predetermined correctness criteria.

16. The method of claim 1 wherein said storing at least one of the one or more answers to the at least one question for which the at least one associated-correct answer is unknown further comprises:
designating the at least one of the one or more answers to the at least one question for which the at least one associated-correct answer is unknown as an expected answer to a future-authentication question.

17. The method of claim 16 wherein the designating the at least one of the one or more answers to the at least one question for which the at least one associated-correct answer is unknown as an expected answer to a future-authentication question includes:
receiving an identification of at least one (a) more preferred topic area for the future-authentication question, (b) less preferred topic area for the future-authentication question, or (c) indication of a declination to answer the future-authentication question.

18. The method of claim 1 further comprising:
receiving a communication request for authentication.

19. The method of claim 1 further comprising:
disallowing an authentication if the one or more answers to the at least one question for which the at least one associated-correct answer is known fail to meet one or more predetermined criteria.

20. The method of claim 1 further comprising:
allowing an authentication if the one or more answers to the at least one question for which the at least one associated-correct answer is known meet one or more predetermined criteria.

21. The method of claim 20 wherein the allowing an authentication if the one or more answers to the at least one question for which the at least one associated-correct answer is known meet one or more predetermined criteria includes:
determining a fault tolerance level, the fault tolerance based on one or more security settings.

22. A computer program product comprising:
a signal bearing medium bearing;
one or more instructions for posing at least one question for which at least one associated-correct answer is known;
one or more instructions for receiving one or more answers to the at least one question for which the at least one associated-correct answer is known;
one or more instructions for posing at least one question for which at least one associated-correct answer is unknown;
one or more instructions for receiving one or more answers to the at least one question for which the at least one associated-correct answer is unknown; and
one or more instructions for storing at least one of the one or more answers to the at least one question for which the at least one associated-correct answer is unknown.

23. The computer program product of claim 22 wherein the signal bearing medium comprises:
a recordable medium.

24. The computer program product of claim 22 wherein the signal bearing medium comprises:
a transmission medium.

25. The computer program product of claim 22 wherein the one or more instructions for posing at least one question for which at least one associated-correct answer is known includes:
one or more instructions for posing at least one question from a selected subset, the selected subset from a set of two or more questions with known answers.

26. The computer program product of claim 25 wherein the one or more instructions for posing at least one question from a selected subset, the selected subset from a set of two or more questions with known answers includes:
one or more instructions for determining a size of a randomly selected subset according to a security level for the authenticating the user.

27. The computer program product of claim 25 wherein the one or more instructions for posing at least one question from a selected subset, the selected subset from a set of two or more questions with known answers includes:
one or more instructions for preparing a randomly selected subset via including one or more questions chosen by the user to be authenticated.

28. The computer program product of claim 25 wherein the one or more instructions for posing at least one question from a selected subset, the selected subset from a set of two or more questions with known answers includes:
one or more instructions for preparing a randomly selected subset via excluding one or more questions for which the system receives a predetermined number of incorrect answers.

29. The computer program product of claim 25 wherein the one or more instructions for posing at least one question from a selected subset, the selected subset from a set of two or more questions with known answers includes:
one or more instructions for preparing a randomly selected subset via including one or more questions pertaining to a recent user electronic transaction.

30. The computer program product of claim 29 wherein the one or more instructions for preparing a randomly selected subset via including one or more questions pertaining to a recent user electronic transaction includes:
one or more instructions for determining the recent user electronic transaction via monitoring one or more of a banking transaction, a travel transaction, a payment transaction, an email transaction, and/or a credit card transaction.

31. The computer program product of claim 25 wherein the one or more instructions for posing at least one question from a selected subset, the selected subset from a set of two or more questions with known answers includes:
one or more instructions for including one or more questions that enable one or more of yes/no answers, multiple choice answers, and/or defined number of syllable answers.

32. The computer program product of claim 22 wherein the one or more instructions for posing at least one question for which at least one associated-correct answer is unknown includes:
one or more instructions for posing one or more questions for purposes of building a database of questions and/or answers for a future authentication session.

33. The computer program product of claim 22 wherein the one or more instructions for receiving one or more answers to the at least one question for which the at least one associated-correct answer is unknown includes:
one or more instructions for receiving one or more answers to the at least one question for which the at least one associated-correct answer is unknown.

34. The computer program product of claim 33 wherein the one or more instructions for receiving the one or more answers to the at least one question for which the at least one associated-correct answer is unknown in forms structured to prevent an eavesdropper from determining the at least one question for which the at least one associated-correct answer is unknown includes:
one or more instructions for receiving at least one answer to one or more questions that enable one or more of yes/no answers, multiple choice answers, and/or defined number of syllable answers.

35. The computer program product of claim 33 wherein the one or more instructions for receiving the one or more answers to the at least one question for which the at least one associated-correct answer is unknown in forms structured to prevent an eavesdropper from determining the at least one question for which the at least one associated-correct answer is unknown includes:
one or more instructions for receiving one or more answers chosen from a string of potential answers.

36. The computer program product of claim 22 wherein the one or more instructions for said storing at least one of the one or more answers to the at least one question for which the at least one associated-correct answer is unknown further comprises:
one or more instructions for storing the at least one of the one or more answers to the at least one question for which the at least one associated-correct answer is unknown at least partially conditional upon at least one of the one or more answers to the at least one question for which the at least one associated-correct answer is known.

37. The computer program product of claim 36 wherein one or more instructions for said storing the at least one of the one or more answers to the at least one question for which the at least one associated-correct answer is unknown at least partially conditional upon at least one of the one or more answers to the at least one question for which the at least one associated-correct answer is known further comprises:
one or more instructions for forestalling the storing in response to the at least one of the one or more answers to the at least one question for which the at least one associated-correct answer is known failing to meet one or more predetermined correctness criteria.

38. The computer program product of claim 36 wherein one or more instructions for said storing the at least one of the one or more answers to the at least one question for which the at least one associated-correct answer is unknown at least partially conditional upon at least one of the one or more answers to the at least one question for which the at least one associated-correct answer is known further comprises:
one or more instructions for activating the storing in response to the at least one of the one or more answers to the at least one question for which the at least one associated-correct answer is known meeting one or more predetermined correctness criteria.

39. The computer program product of claim 22 wherein the one or more instructions for said storing at least one of the one or more answers to the at least one question for which the at least one associated-correct answer is unknown further comprises:
one or more instructions for designating the at least one of the one or more answers to the at least one question for which the at least one associated-correct answer is unknown as an expected answer to a future-authentication question.

40. The computer program product of claim 39 wherein the designating the at least one of the one or more answers to the at least one question for which the at least one associated-correct answer is unknown as an expected answer to a future-authentication question includes:
one or more instructions for receiving an identification of at least one (a) more preferred topic area for the future-authentication question, (b) less preferred topic area for the future-authentication question, or (c) indication of a declination to answer the future-authentication question.

41. The computer program product of claim 22 further comprising:
one or more instructions for receiving a communication request for authentication.

42. The computer program product of claim 22 further comprising:
one or more instructions for disallowing an authentication if the one or more answers to the at least one question for which the at least one associated-correct answer is known fail to meet one or more predetermined criteria.

43. The computer program product of claim 22 further comprising:
one or more instructions for allowing an authentication if the one or more answers to the at least one question for which the at least one associated-correct answer is known meet one or more predetermined criteria.

44. The computer program product of claim 43 wherein the one or more instructions for allowing an authentication if the one or more answers to the at least one question for which the at least one associated-correct answer is known meet one or more predetermined criteria includes:
one or more instructions for determining a fault tolerance level, the fault tolerance based on one or more security settings.

45. A communication device comprising:
a processor;
audio input and/or output circuitry coupled to the processor;
a memory coupled to the processor; and
a security module coupled to the processor, the security module configured to determine whether the processor should implement a secure protocol, the secure protocol configured to implement an automated system with one or more questions related to security/authentication and/or fact gathering, the security module configured to include:
a question and/or answer module configured to
pose at least one question for which at least one associated-correct answer is known;
receive one or more answers to the at least one question for which the at least one associated-correct answer is known;
pose at least one question for which the at least one associated-correct answer is unknown;
receive one or more answers to the at least one question for which the at least one associated-correct answer is unknown; and
store the one or more answers to the at least one question for which the at least one associated-correct answer is unknown.

46. The communication device of claim 45 wherein the security module is coupled to the processor, located within the processor, and/or located in the memory.

47. The communication device of claim 45 wherein the memory is one or more of random access memory, read only memory, an optical memory, or a subscriber identity module memory.

48. The communication device of claim 45 wherein the audio input and output circuitry includes one or more of a microphone, a speaker, a transducer, and audio input and/or output circuitry.

49. The communication device of claim 45 further comprising a housing coupled to the processor, the housing encasing the memory, the processor, and the audio input and output circuitry.
